(19) United States
(12) Patent Application Publication
(10) Pub. No.: US 2026/0062207 A1
(43) Pub. Date: Mar. 5, 2026

(54) BIN STATUS SYSTEM AND METHOD

(71) Applicant: XORRO PTY LTD, Osborne Park, Western Australia (AU)

(72) Inventors: Leonard LUXFORD, Osborne Park, Western Australia (AU); Zyrus KHAMBATTA, Osborne Park, Western Australia (AU); Rohan WALLACE, South Perth, Western Australia (AU)

(73) Assignee: XORRO PTY LTD, Osborne Park, Western Australia (AU)

(21) Appl. No.: 19/105,463

(22) PCT Filed: Aug. 23, 2023
(86) PCT No.: PCT/AU2023/050812

§ 371 Date: Feb. 21, 2025

(30) Foreign Application Priority Data
Aug. 23, 2022 (AU) 2022902413

(51) Int. Cl. B65F 1/14; B65F 1/00; G06Q 10/30

(52) U.S. Cl. CPC B65F 1/14; B65F 1/0053; G06Q 10/30; B65F 2210/128; B65F 2210/144; B65F 2210/152; B65F 2210/168

(57) ABSTRACT

A system for indicating bin status involving a bin sensor measuring waste level and status and transmitting this information along with an identifier associated with the bin's location. The system also includes a receiver, processor, transmitter, and a device. The processor determines when collection of waste is pending based on the bin's location and scheduling information. The transmitter sends the device information about the level of rubbish in the bin, the status of bin and an indication when the collection of waste is pending. The device displays the level of waste, status, and collection indications for the bin assigned to the location, ensuring efficient waste management.

### FIELD OF THE INVENTION

The present invention relates to a system for determining and indicating the status of a bin remotely from the bin and a method of determining and indicating the status of a bin remotely from the bin.

### BACKGROUND

The following discussion of the background art is intended to facilitate an understanding of the present invention only. It should be appreciated that the discussion is not an acknowledgement or admission that any of the material referred to was part of the common general knowledge as at the priority date of the application.

Household waste is often placed in a bin and collected, say weekly (but other frequencies are common), by a kerbside collection truck when it is placed on the roadside kerb. Household waste is placed in the kerbside bin as required, usually multiple times between each kerbside collection. The kerbside bin is often stored outside or in a garage, remotely from the inside of the house. It is usually not recalled how much waste is in the bin or the amount of waste in the bin is unknown by different members of the household. It would be useful for members of the household to know how much waste is in the bin without needing to directly look inside the bin.

The members of the household must remember to put the bin out on the kerbside before the collection truck arrives. However, it is known for members of the household to forget to put the bin out in time, resulting in missing the collection by the collection truck.

During windy conditions a bin can sometimes be blown over or may be knocked over by other means. It would be useful to know if the bin has been knocked over without needing direct visual observation.

If the bin is knocked over or if the bin lid is not closed, wildlife, and in particular birds, can pull out items in the bin to try to get food. This creates a mess. It would be useful to know if the bin lid is open without direct visual observation.

The present invention has been developed within the context of this background.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF THE INVENTION

According to an aspect of the present invention there is provided a device that is separate from a bin for indicating status of the bin allocated to a location, comprising a receiver for receiving a signal from a server only in respect of the bin allocated to the location indicating one or more of: the level of waste in the bin, a signal of the status of the bin, and a signal indicating collection of waste from the bin is pending;
a processor for processing the or each of the signals and activation of a display accordingly; wherein the display is configured to display in respect of the bin allocated to the location at least one of: the level of waste in the bin; the status of the bin, and whether collection of waste from the bin is pending.

In an embodiment the device is allocated to the location.

In an embodiment the device is configured to display in respect of other bins allocated to the location at least one of: the level of waste in each bin; whether any of the bins are not in a safe state and whether collection of waste from one or more of the bins is pending.

According to another aspect of the present invention there is provided a system for indicating the status of a bin, comprising:
a bin sensor configured to measure the level of waste in a bin allocated to a location and/or the status of the bin, wherein the bin sensor is configured to transmit the level of waste in the bin and/or the status of the bin along with one or both of an identifier of the bin, where the identifier is associated with the allocated location;
a receiver of the transmission from the bin;
a processor configured to determine an indicator of when collection of waste from the bin is pending based on the location of the bin and scheduling information about when the bin or a group of bins including the bin is expected to have its waste collected;
a transmitter in respect of the bin allocated to the location of one or more of: the level of rubbish in the bin, the status of the bin and an indication of when collection of waste from the bin is pending; and
a device configured to receive the transmitted one or more of: level of waste in the bin, the status of the bin and the indication of when collection of waste from the bin is pending, wherein the device is also configured to display in respect of the bin allocated to the location the respective one or more of the level of rubbish in the bin, the status of the bin and the indication of when collection of waste from the bin is pending.

In an embodiment the device is allocated to the location. In an embodiment the location is a street address.

In an embodiment the system comprises a processor configured to determine the indicator of when collection of waste from the bin is pending based on the location and scheduling information about when the bin or a group of bins including the bin is expected to have its waste collected.

In an embodiment the display displays both of the level of waste and that collection of the waste is pending. In an embodiment the display also displays the status of the bin. In an embodiment the display displays a level of waste for each of or a selected one of a plurality of bins allocated to the location, where each bin is allocated to a type of waste. In an embodiment the display displays an indicator of a type of waste that is pending for collection.

According to another aspect of the present invention there is provided a method of indicating the status of a bin allocated to a location comprising:
measuring one or both of: the level of waste in the bin and the status of the bin;
transmitting one or both of the level of waste in the bin and the status of the bin, along with one or both of an identifier of the bin which is associated with a location of the bin;
receiving the transmission from the bin;
transmitting in respect of the bin allocated to the location one or more of: the level of waste in the bin and the status of the bin and the indication of when collection of waste from the bin is pending, to a device separate from the bin;
receiving the transmitted level of waste in the bin and the status of the bin and the indication of when collection of waste from the bin is pending; and
displaying in respect of the bin allocated to the location the level of waste in the bin and the status of the bin and the indication of when collection of waste from the bin is pending.

In an embodiment the method further comprises determining when collection of waste from the bin is pending based on the location of the bin and scheduling information about when the bin or a group of bins at or within an area are expected to have its waste collected. In an embodiment the method further comprises determining when collection of waste from the bin is pending based on the location of the collection truck and its proximity to the location of the bin.

In an embodiment the display is configured to display when the collection of waste from the bin is imminent. In an embodiment the collection is imminent when the collection truck is within a defined scheduled time before estimated collection at the location of the bin, and/or when the collection truck is within a defined distance from the location of the bin.

In an embodiment the status of the bin comprises whether the bin is upright or tipped over. In an embodiment the status if the bin comprises whether a lid of the bin is open or closed. In an embodiment the bin is regarded as being in a safe status when the bin is upright and the bin lid is closed. In an embodiment the bin is regarded as being in an unsafe state when the bin is not upright or if the bin lid is open for longer than a predetermined period of time.

In an embodiment the level of waste in the bin is measured by directing a beam from a sensor into the bin and determining the distance of waste in the bin from the top.

In an embodiment the status of upright or tipped is determined by determining whether the body of the bin is respectively substantially vertical or substantially horizontal. In an embodiment the status of the bin is determined by determining an angle of the lid of the bin, where the angle remains static for a substantial amount of time. When the lid is horizontal and right way up, the bin is regarded as upright with the lid closed. When the lid is horizontal and upside down the bin is regarded as tipped over. When the lid is vertical the bin is regarded as upright with the bin lid open.

In an embodiment the angle from horizontal is measured by the sensor. In an example one or more tilt switches can be used to measure the angle from horizontal. In an alternative an accelerometer can be used to measure the angle from horizontal.

In an embodiment the waste is expended to be collected when the bin sensor receives a proximity signal from the waste collection truck.

In an embodiment the waste is expected to be collected according to a time of day window in which the waste is expected to be collected. In an embodiment the waste is expected to be collected when it is the day of the week in which waste is collected scheduled to be collected from the bin.

In an embodiment the device comprises a fastener for fixing the device in place. In an embodiment the fastener comprises a magnet for fastening of the device to a ferrous object, such as for example a refrigerator.

In an embodiment the device is a mobile phone. In an alternative the device is configured to communicate with a mobile phone so that is can then receive the transmission via a network. In an embodiment the device is a fridge magnet. In an embodiment the device connects to a mobile phone, such as by Bluetooth. In an embodiment the device connects to a cloud server on the internet by WiFi.

In an embodiment the indication of the level of waste in the bin is displayed on the mobile phone. In an embodiment the display of the level of waste is in the form of illumination of one or more lights (eg. LEDs) according to the level of waste. In an embodiment the indication of the status is display on the mobile device of whether the bin is upright or tipped and whether the lid is open or closed.

In an embodiment the indication of the status comprises illumination of a light when the bin is tipped over and/or when the lid is left open too long.

In an embodiment the bin sensor comprises an identification. The identification is registered with a mobile device with a bin App installed. The bin app may for example scan a code of the sensor to obtain the bin sensor ID. The bin sensor ID connects to the internet, for example by connection to a household WiFi, or to the phone providing the WiFi connection details. Alternatively, the bin sensor may connect to the cloud server by a LoRa network.

In an embodiment the location of the bin sensor is recorded either by entering the address, by using a GPS location of the bin sensor or by receiving the location from the mobile phone.

In an embodiment the recorded location is used to determine when the expected collection of waste is for that location.

### BRIEF DESCRIPTION OF DRAWINGS

In order to provide a better understanding, embodiments of the present invention will be described, by way of example only, with reference to the accompanying drawings, in which:

FIG. 1 is schematic diagram of a system according to an embodiment of the present invention;

FIG. 2 is schematic diagram of a device according to an embodiment of the present invention;

FIG. 3 is a block diagram of elements of the device according to an embodiment of the present invention,

FIG. 4 is a diagram of circuitry of the device according to an embodiment of the present invention;

FIG. 5 is a message flow diagram of messages from a sensor to a display device according to an embodiment of the present invention;

FIG. 6 is a message flow diagram of messages from a server to a display device according to an embodiment of the present invention;

FIG. 7 is a message flow diagram of messages from collection trucks to a display device according to an embodiment of the present invention; and

FIGS. 8A and 8B are collectively a flow chart of a method of determining a bin fall status according to an embodiment of the present invention.

### DESCRIPTION OF EMBODIMENTS

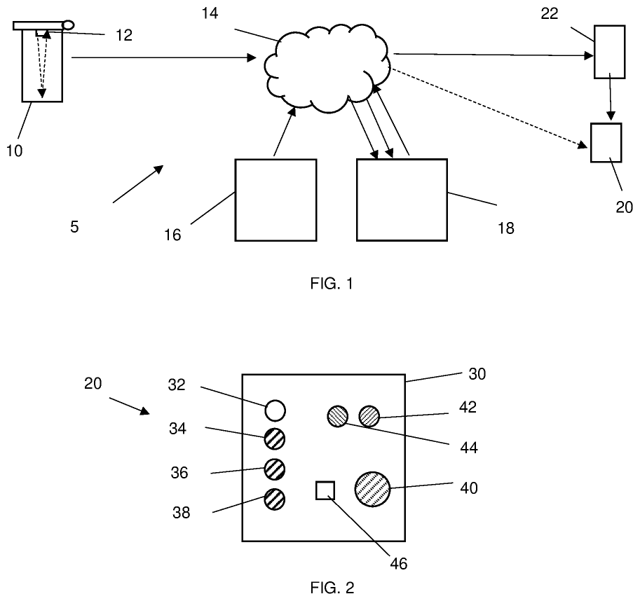

Referring to FIG. 1, there is an embodiment of a system 5 for in indicating the status of a bin 10. The bin 10 in this embodiment is a standard kerbside bin with a lid that swings open from hinges at one edge. These bins are commonly known as ‘wheelie bins’. Each street address (location) is usually allocated at least one bin. Sometimes a different bin is allocated for each different type of waste, for example, general waste, recycling (sometimes of different types) and green waste. There is a bin sensor 12 configured to measure the level of waste in each bin 10. In an embodiment the level of waste in the bin 10 is measured by directing a beam from the sensor 12 into the bin 10 and determining the distance of waste in the bin 10 from the top. The allocation of the sensor 12 to the bin (preferably its type) and thus the location of the/each bin is recorded, such as by a server 18.

In this embodiment the sensor 12 is mounted to or inside of the bin lid and may be as described in WO 2021/151171 A1 and/or WO 2014/063184 A1, the contents of each is incorporated herein by reference. In an embodiment the bin sensor 12 is able to determine the status of the bin, such as whether the bin is upright, or tipped over and/or whether the bin lid is open or closed. In an embodiment the bin sensor 12 is provided with an identifier which by association is able to identify the bin 10. In addition, or alternatively the bin sensor 12 is able to determine its location (such as by GPS location). The bin sensor 12 is configured to transmit the level of waste in the bin and/or the status of the bin along with one or both of the identifier and the location of the bin 10 to a destination, such as server 18, via a computer network 14, such as the Internet.

The system 5 also comprises a waste collection management system 16 comprising a computer configured to store or determine scheduling information about when the bin 10 or a group of bins including the bin 10 (such as bins at each household, bins in a street, group of streets or a suburb) is expected to have its/their waste collected. This may be as simple as these bins (including the bin 10) have their waste collected on a certain day of the week (or some other time period) or it may track the location of the waste collecting truck and be able to approximate when (in terms of a time of day) the waste will be collected. The waste collection management system 16 may also provide scheduling information about different waste type collection, as it is common for bins holding different types of waste (eg. general waste, green waste, recycling sometimes by different type) to be collected at different times/days. This scheduling information may be sent to or collected by the server 18.

The server 18 comprises a receiver of the transmission from the sensor 12 and a processor configured to determine an indicator of when collection of waste from the bin is pending based on the location of the bin 10 and scheduling information about when the bin 10 is expected to have its waste collected. The indicator may be in the form of a time period, such as for example between 6 am and 9 am on a Wednesday. The server 18 may do this for a plurality of bins, such as the different types of waste bin for each street address, and the bins for a plurality of households that each have a device 20. The information in the transmission is allocated to the particular bin (at a particular location and possibly of a particular waste type) by an identifier associated with the sensor 12.

The server 18 comprises a transmitter of one or more of: the level of rubbish in the bin for that location (for a street address), the status of the bin and an indication of when collection of waste from the bin is pending to the device 20, via the network 14. This transmission may be via another device 22; such as a local gateway device (for example a Google™ home device, or similar products from Apple™ or Alexa™ (by Amazon™) or other brands), or it may be a smartphone. The transmitter is arranged to transmit this information to the device 20 allocated to the particular bin or to the location of the bin(s).

The device 20 is allocated to a particular location (street address) and the bin (or bins) allocated to that location. This allocation may be recorded in the server 18. Alternatively, it may be stored in the sensor 12 and the sensor 12 may direct the information to the device 20. In another alternative, an identifier of the sensor 12 may be stored in the device 20 and the device 20 may request information for the relevant sensor 12.

The device 20 is configured to receive the transmitted one or more of: level of waste in the bin, the status of the bin and the indication of when collection of waste from the bin is pending. The device 20 is also configured to display the respective one or more of the level of rubbish in the bin(s) allocated to the location, the status of the bin(s) allocated to the location and the indication of when collection of waste from the bin(s) allocated to the location is pending, such as with a display screen or lights.

The device 20 is separate from the bin 20 so that it may be located as a convenient location for indicating the status of the bin 10 to, for example, a household. An example location is on a refrigerator. Accordingly, the device may comprise a magnet on its back for attachment of the device 20 to a ferrous object. Accordingly, the device 20 may take the form of a fridge magnet.

Referring to FIG. 2, an example of the device 20 is shown, in which there are a plurality of lights 32, 34, 36, 38 (such as led lights) for indicating the level of waste in the bin 10. Here three (34, 36 and 38) of the four lights are illuminated, indicating the bin is about ¾ full. A different number of lights can be provided according to the level of granularity of fullness desired to be displayed. The lights may also be differently colours, for example green (38) when the level is low, yellow (36) when about half full, orange (34) when nearing full and red (32) when full. There may be lights for each type of bin or the device 20 may have a selector to select which of a plurality of bins at the address has the level of waste displayed using a single set of lights. The level of waste of the bin displayed may be automatically selected according to which bin has its collection pending.

Light 40 may be illuminated when there is a problem with the status of the bin 10, which as when it is tipped over and/or when the lid has been left open. These statuses may be separately indicated by a separate light each or may be indicated by illumination by a respective colour (for example orange if the lid is open, or red if tipped over). In an embodiment the bin 10 is regarded as being in a safe status when the bin 10 is upright and the bin lid is closed. In an embodiment the bin 10 is regarded as being in an unsafe state when the bin is not upright or if the bin lid is open for longer than a predetermined period of time. Light 40 can display accordingly. Again, there may be a different status light for each bin at the address, or there may be a selector to select the bin that the status light displays the status for. Further there may be a single status light that displays when any of the bins at the address have a status that is not a safe status.

In an embodiment the status of upright or tipped is determined by determining whether a body of the bin 10 is respectively substantially vertical or substantially horizontal. In an embodiment the status of the bin 10 is determined by determining an angle of the lid of the bin 10, where the angle remains static for a substantial amount of time. For example, more than 30 sec, more than 1 min, more than 2 min or more than 5 min. When the lid is horizontal and right way up, the bin 10 is regarded as upright with the lid closed. When the lid is horizontal and upside down the bin 10 is regarded as tipped over. When the lid is vertical the bin 10 is regarded as upright with the bin lid open. When the lid is at an incline (say between 10 and 80 degrees), the bin 10 is regarded as upright with the bin lid not properly closed (which may be regarded as open).

Light 42 may be used to indicate that the collection of waste from the bin is pending. This can serve as a handy reminder to ‘put the bin out’. The method of determining when collection of waste from the bin is pending may be based on the location of the collection truck and its proximity to the location of the bin. For example, determining when collection of waste from the bin is pending may occur when the collection is scheduled for the next day, such as for example in the next 24 hours, or in the next 18 hours, or in the next 12 hours.

In an embodiment the display is configured to display when the collection of waste from the bin is imminent. This might be indicated by blinking light 42. The collection being imminent may be when the collection truck is within a defined scheduled time before estimated collection at the location of the bin, and/or when the collection truck is within a defined distance from the location of the bin, such as for example in the next 4 hours, or in the next 2 hours, or in the next hour, or in the next 30 minutes, or in the next 15 minutes, or within a distance of for example 1 km, or 500 m, or 200 m or 100 m.

Light 44 may be used to indicate the waste type being collected, when there are multiple bins (each of a different type) which are being collected, for example general waste (eg. red), recycling (eg. yellow), green waste (eg. green) on different days/weeks. Lights 42 and 44 could have their functionality combine by the light flashing when collection is pending.

In an embodiment an input button 46 may act as the selector to select which bin at the address the level of rubbish is displayed. There may be an indicator light (separate on in the button 46) to display (for example by colour (green, yellow, red, blue)) which bin has its status being displayed. There may be an indicator light to display which bin type is being collected this week/day.

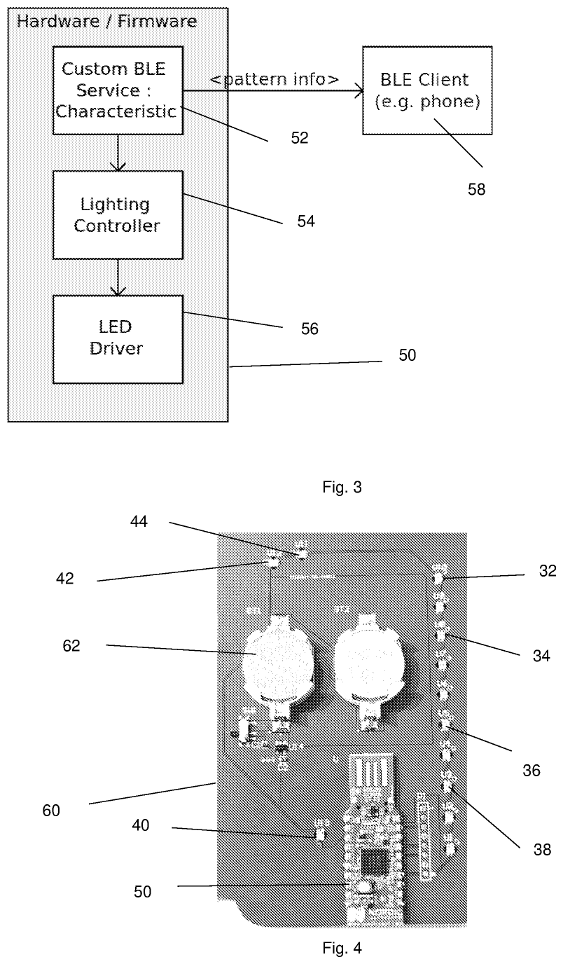

Referring to FIGS. 3 and 4, an embodiment of the device 20 comprises a microcontroller based circuit 60 comprising microcontroller unit 50, a transceiver 52, a lighting controller 54 and LED driver 56 for driving the lights 32 to 44 (and other LEDs U1, U2, U4, U6, U7, U9), and battery(ies) 62. In this embodiment the microcontroller unit 50 comprises a Nordic nRF52840 BT microcontroller to which the string of 13 WS2812 LEDs (U1, U2, 38 (U3), U4, 36 (U5), U6, U7, 34 (U8), U9, 32 (U10), 42 (U12), 44 (U11), 40 (U13)) are connected via a GPIO pin. The transceiver 52 operates a BLE Service that connects by Bluetooth v5 protocol (solid line between 22 and 20 in FIG. 1) to a BLE client 58, such as an App running in the device 22.

Preferably the App in the device 22 is able to display at least the same information as the device 20. The App may also provide additional information such as weather conditions and warning of extreme weather and may provide waste collection comparisons to averages or neighbours.

BLE service 52 (notionally 00dae901-132b-4a37-83fa-0c6a10cf5465) is exposed by Bluetooth connection method for the client 58 of the App in the device 22 to connect to.

In an example, the service 52 exposes two characteristics: 00dae903-132b-4a37-83fa-0c6a10cf5465 (write):
format is: 0x AA MM LL
where: AA=string no (in this case, there is only one string, so 00)
where: MM=uint16_t MSB of no of LEDs in string
where: LL=uint16_t LSB of no of LEDs in string

Writing to this characteristic stores the string length in non-volatile memory. 00dae907-132b-4a37-83fa-0c6a10cf5465 (write):
format is: 0x AA R0 G0 B0 R1 R1 B1 . . . Rn Gn Bn
where: AA=string no (in this case, there is only one string, so 00)
where: R0 . . . Rn=red value of nth LED
where: G0 . . . Gn=green value of nth LED
where: B0 . . . Bn=blue value of nth LED

Writing to this characteristic does two things:
1. Confirms the number of bytes is expected based on this string length
2. If correct forwards the relevant data on to the Light Controller which creates a driver-compatible data structure which is the forwarded onto the driver to suitably modulate the interface pin to render the desired lighting arrangement.

In an alternative embodiment the device 20 connects to the server 18 such as by a home WiFi network (dashed line in FIG. 1) to receive the status information.

In an embodiment the bin sensor identification is registered with the App in order to associate the bin sensor 12 with the App. The bin App may for example scan a QR code of the sensor 12 to obtain the bin sensor ID so as to enable to App to receive the status information from the bin sensor 12, via server 18. In some embodiment the server 18 may be omitted if the sensor is able to communicate directly with the device 20/App in device 22 and the collection information is able to be obtained directly from system 16.

The bin sensor 12 connects to the internet 14, for example by connecting to a household WiFi, by for example the phone providing the WiFi connection details over a Bluetooth connection between the App and the bin sensor 12. Alternatively, the bin sensor 12 may connect to the cloud server by another network, such as a LoRa network. Other connection possibilities include using a low-power mesh networking standard such as Thread or through other RF technology such as Zigbee or an alternative as for example provided by Nordic providing IP connectivity similar to Wi-Fi.

In an embodiment the location of the bin sensor is recorded either by entering the address, by using a GPS location of the bin sensor 12 or by receiving the location from the smartphone 22.

An example method of operation of the present invention is now described with reference the description above.

The method of indicating the status of a bin comprises: measuring one or both of: the level of waste in the bin and the status of the bin; transmitting one or both of the level of waste in the bin and the status of the bin, along with one or both of an identifier of the bin which is associated with a location of the bin and the location of the bin; receiving the transmission from the bin; transmitting one or more of: the level of waste in the bin and the status of the bin and the indication of when collection of waste from the bin is pending, to a device separate from the bin; receiving the transmitted level of waste in the bin and the status of the bin and the indication of when collection of waste from the bin is pending; and displaying the level of waste in the bin and the status of the bin and the indication of when collection of waste from the bin is pending.

The method may further comprise determining when collection of waste from the bin is pending based on the location of the bin and scheduling information about when the bin or a group of bins at or within an area are expected to have its waste collected.

In an embodiment the waste is expended to be collected when the bin sensor receives a proximity signal from the waste collection truck. In an embodiment the waste is expected to the collected when the truck is determined to be within 200 m, 500 m 1 km or 2 km of the bin.

In an embodiment the waste is expected to be collected according to a time of day window in which the waste is expected to be collected. In an embodiment the waste is expected to be collected when it is the day of the week in which waste is collected scheduled to be collected from the bin.

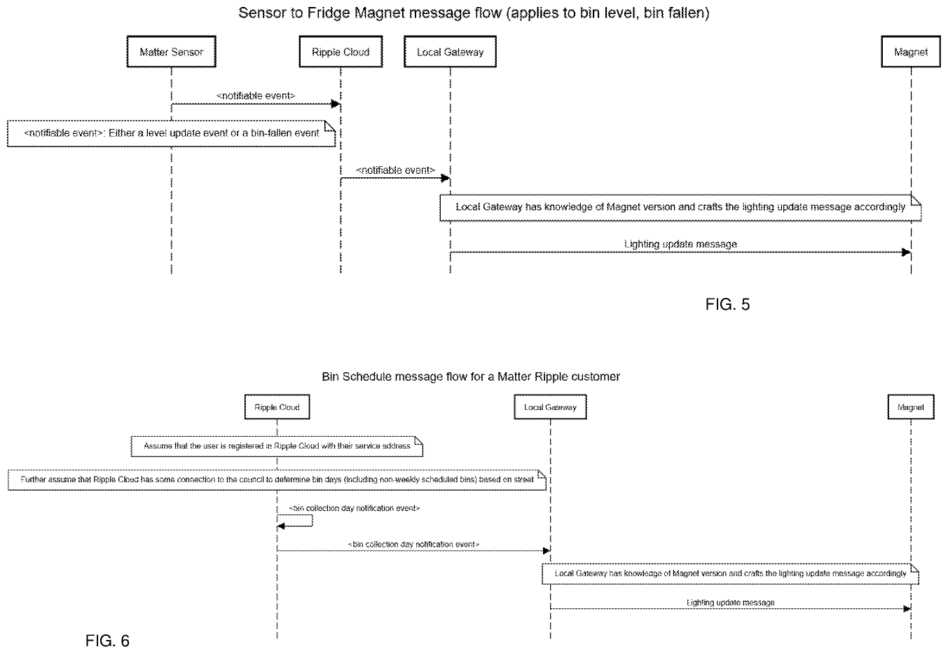

FIG. 5 shows an example of message flow from the Sensor 12 (termed Matter Sensor in the Figure) to the Device 20 (termed Magnet in the Figure) via the Server 18 (termed Ripple Cloud in the Figure) and the gateway 22 (Termed Local Gateway in the Figure). The sensor 12 is configured to determine when a notifiable event occurs and then sends a message of the notifiable event to the Server 18, which in turn is sent to the gateway 22. The gateway 22 receives the notification and formats a message as to what the lights should display and then sends a lighting update message to the device 20. In an alternative the server 18 could prepare the lighting update message instead of the gateway 22.

An example message protocol is below:
title Sensor (12) to Device (20) message flow (applies to bin level, bin fallen)
participant Bin Sensor (12)
participant Cloud Server (18)
participant Local Gateway (22)
participant Device (20)
Sensor->Server:<notifiable event>
note over Sensor:<notifiable event>:Either a level update event or a bin-fallen event
Server->Local Gateway:<notifiable event>
note over Local Gateway, Device:Local Gateway has knowledge of Device version
and crafts the lighting update message accordingly
Local Gateway->Device:Lighting update message

FIG. 6 shows an example message flow from the Server 18 (termed Ripple Cloud in the Figure) to the Device 20 (termed Magnet in the Figure) via the gateway 22 (Termed Local Gateway in the Figure). In the Figure ‘Council’ is the management system 16. The system 16 determines a collection day for the location of the bin 10. In this example the system sends a notification of a collection day to the Server 18. Alternatively, the server may request the collection day. The server 20 prepares a lighting update message to the device 20.

An example message protocol is below:
title Bin Schedule message flow for an App customer
participant Cloud Server (18)
participant Local Gateway (22)
participant Device (20)
note over Cloud Server: Assume that the user is registered in Cloud with their service address
note over Cloud:Further assume that Cloud has some connection to the council to determine bin days (including non-weekly scheduled bins) based on street
Cloud Server->Cloud Server:<bin collection day notification event>
Cloud Server->Local Gateway:<bin collection day notification event>
note over Local Gateway, Device:Local Gateway has knowledge of Device version and crafts the lighting update message accordingly
Local Gateway->Device:Lighting update message

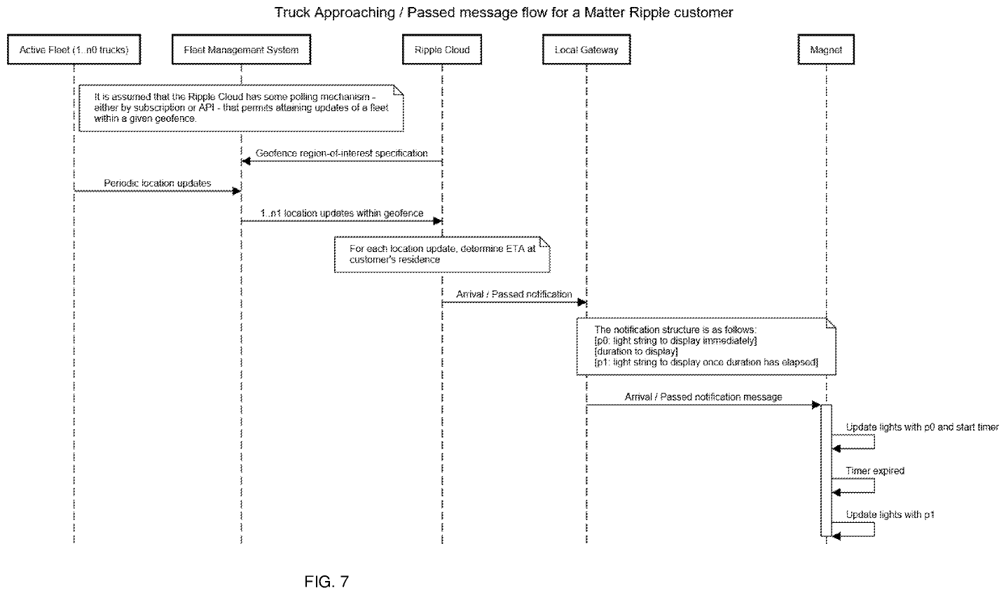

FIG. 7 shows an example message flow from Waste Collection Trucks to the Device 20 (termed Magnet in the Figure) via system 16 (termed Fleet Management System in the Figure), the Server 18 (termed Ripple Cloud in the Figure) and the gateway 22 (Termed Local Gateway in the Figure). Collection trucks provide location updates to the system 22 periodically. Geofences are created according to each trucks collection region/route. The location of the truck is updated within the respective geofence. The server 18 determine an ETA of the truck at each bin's location (termed customer's residence in the Figure). The pending arrival is passed to the gateway 22. Light update message is sent to the device 20. The device tracks timing of the display of lights according to the content of the message.

An example message protocol is below:
title Truck Approaching/Passed message flow for an App customer
participant Active Fleet (1 . . . n0 trucks)
participant Fleet Management System (16)
participant Cloud Server (18)
participant Local Gateway (22)
participant Device (20)
note over Fleet Management System:It is assumed that the Cloud Server has some
polling mechanism—\neither by subscription or API—that permits attaining updates of a fleet\within a given geofence.
Cloud Server->Fleet Management System:Geofence region-of-interest specification Active Fleet (1 . . . n0 trucks)->Fleet Management System:Periodic location updates Fleet Management System->Cloud Server:1 . . . n1 location updates within geofence note over Cloud Server:For each location update, determine ETA at\ncustomer's residence
Cloud Server->Local Gateway:Arrival/Passed notification
note over Local Gateway, Device:The notification structure is as follows:\n[p0:light string to display immediately]\n[duration to display]\n[p1:light string to display once duration has elapsed]
Local Gateway->Device:Arrival/Passed notification message
activate Device
Device->Device:Update lights with p0 and start timer
Device->Device:Timer expired
Device->Device:Update lights with p1
deactivate Device

In an embodiment the angle from horizontal is measured by the sensor. In an example one or more tilt switches can be used to measure the angle from horizontal. In an alternative an accelerometer can be used to measure the angle from horizontal.

In an embodiment bin-fallen detection is the determination of movement outside a probabilistic arc and/or resting lid position, i.e.:
The vast majority of sensor motion will occur due to the lid opening and closing. Once the sensor is mounted, this arc is deterministic, as is the resting position.
To be truly deterministic, the geometry of the sensor relative to the hinge point and the exact mounting orientation needs to be known ahead of time—this is not practical.
In lieu of absolute determinism, one can assess the likelihood that, based on the observed motion, that the motion is essentially expected or unexpected.

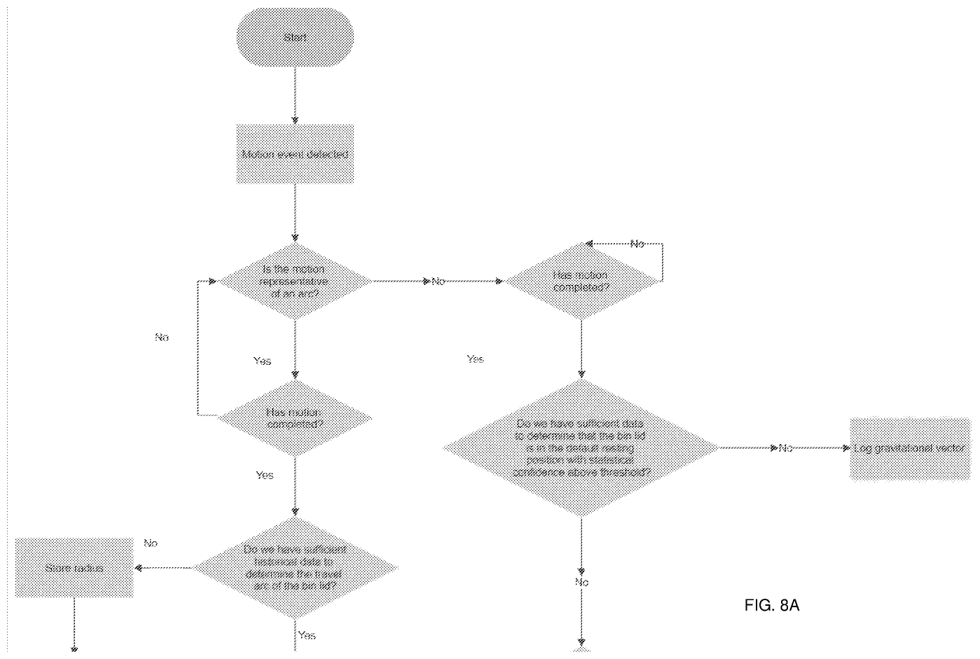

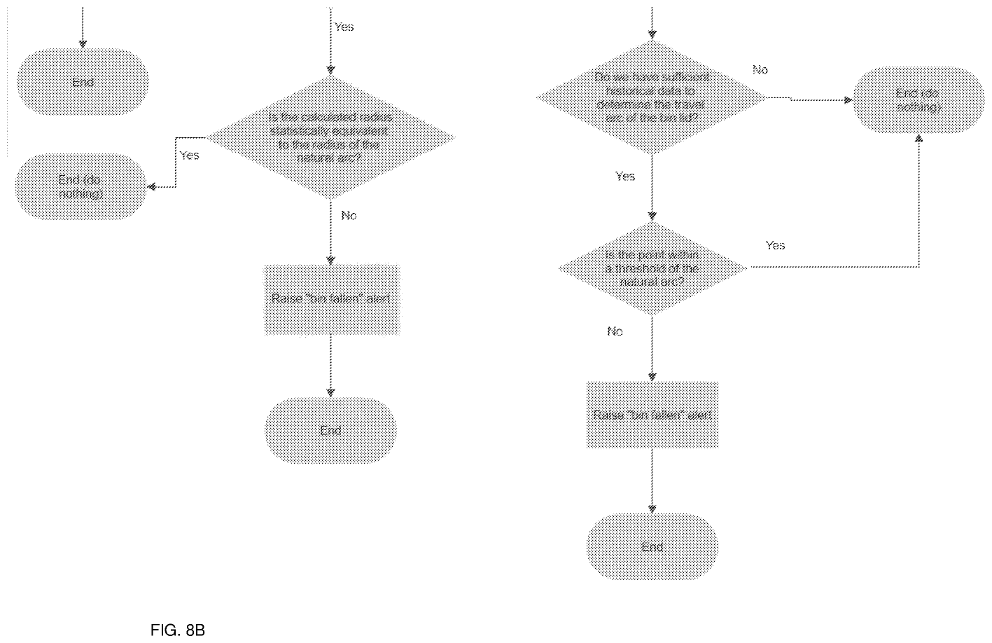

FIGS. 8A and 8B show a method of determining when a bin has fallen.

Modifications may be made to the present invention within the context of that described and shown in the drawings. Such modifications are intended to form part of the invention described in this specification.

1.-19. (canceled)

20. A device that is separate from a bin for indicating information about the bin allocated to a location, the device being allocated to the location, the device comprising
a receiver for receiving signals from a server in respect of the bin allocated to the location, each signal indicating one or more of:
the level of waste in the bin, a status of the bin, and an indication that collection of waste from the bin is pending;
a processor for processing each of the signals and activation of a display accordingly;
wherein the display is configured to display in respect of the bin allocated to the location at least one of: the level of waste in the bin; the status of the bin and whether collection of waste from the bin is pending.

21. A device that is separate from a bin for indicating information about the bin allocated to a location, the device comprising
a receiver for receiving signals from a server in respect of the bin allocated to the location indicating collection of waste from the bin is pending;
a processor for processing the signal and activation of a display to display in respect of the bin allocated to the location whether collection of waste from the bin is pending.

22. A device according to claim 21, wherein the signal from the server in respect of the bin allocated to the location also indicates one or more of:
the level of waste in the bin, and the status of the bin;
wherein the processor processes the signal and activates the display to indicate at least one of:
the level of waste in the bin; and
the status of the bin.

23. A device according to claim 21, wherein the device is allocated to the location and has an attachment mechanism for attaching it in place at the location.

24. A device according to claim 20, wherein the display displays at least both of the level of waste and the status of the bin.

25. A device according to claim 20, wherein the display displays a level of waste for each of or a selected one of a plurality of bins allocated to the location, where each bin is allocated to a type of waste.

26. A device according to claim 25, wherein the display displays an indicator of a type of waste that is pending for collection.

27. A device according to claim 20, wherein when the received signal includes an indication that collection of the bin is imminent, the processor changes the display of the collection of waste from the bin is pending to a display that the collection is imminent.

28. A device according to claim 20, wherein the bin is one of a plurality of bins allocated to the location and each bin is allocated to a different type of waste; wherein the receiver is configured to receive the signal, wherein the signal indicates one or more of:
the level of waste in one or more of the bins, the status of one or more of the bins, and an indication that collection of a respective type of waste is pending;
wherein the display is configured to display in respect of each bin:
the level of waste in each bin;
the status of each bin and whether collection of waste of the respective type is pending for each bin; and
wherein the processor is configured to process each of the signals and activate the display according to processing of each of the signals.

29. A system for indicating the information about a bin, comprising:
a device allocated to a location of the bin;
a bin sensor allocated to the location of the bin, the bin sensor configured to measure the level of waste in the bin and/or a status of the bin, wherein the bin sensor is configured to transmit the level of waste in the bin and/or the status of the bin along with an identifier of the bin, where the identifier is associated with the allocated location;
a receiver of the transmission from the bin sensor;
a processor configured to determine when collection of waste from the bin is pending based on the location of the bin and scheduling information about when the bin or a group of bins including the bin is expected to have its waste collected;
a transmitter for transmitting to the device one or more of:
the level of rubbish in the bin, the status of the bin and an indication that collection of waste from the bin is pending; and
wherein the device is configured to receive the transmitted one or more of:
level of waste in the bin, the status of the bin and whether collection of waste from the bin is pending,
wherein the device is also configured to display in respect of the bin allocated to the location the respective one or more of: the level of rubbish in the bin, the status of the bin and the whether collection of waste from the bin is pending.

30. A system according to claim 29, wherein the display displays at least both of the level of waste and whether collection of the waste is pending.

31. A system according to claim 30, wherein the display also displays the status of the bin.

32. A system according to claim 29, wherein the display displays a level of waste for each of or a selected one of a plurality of bins allocated to the location, where each bin is allocated to a type of waste.

33. A system according to claim 32, wherein the display displays an indicator of a type of waste that is pending for collection.

34. A system according to claim 29, wherein the processor determines whether the collection is imminent and when collection is imminent transmits a signal to the device that collection from the bin is imminent; wherein the device changes the display of the collection of waste from the bin is pending to a display that the collection is imminent.

35. A method of indicating information about a bin allocated to a location comprising:
measuring one or both of: the level of waste in the bin and a status of the bin;
transmitting one or both of the level of waste in the bin and the status of the bin, along with one or both of an identifier of the bin which is associated with a location of the bin;
receiving the transmission from the bin;
transmitting in respect of the bin allocated to the location one or more of:
the level of waste in the bin and the status of the bin and the indication of when collection of waste from the bin is pending, to a device separate from the bin, where the device is allocated to the location;
receiving at the device the transmitted level of waste in the bin and the status of the bin and the indication of when collection of waste from the bin is pending; and
displaying on the device the level of waste in the bin and the status of the bin and an indication that collection of waste from the bin is pending.

36. A method according to claim 35, wherein the method further comprises determining when collection of waste from the bin is pending based on the location of the bin and scheduling information about when the bin or a group of bins at or within an area are expected to have its waste collected.

37. A method according to claim 36, wherein the method further comprises determining when collection of waste from the bin is pending based on the location of a collection truck and its proximity to the location of the bin.

38. A method according to claim 35, further comprising receiving at the device allocated to the location an indication that the collection is imminent and changing the display from indicating that the collection is pending to display that the collection of waste from the bin is imminent.

39. A method according to claim 35, wherein the status of the bin comprises whether the bin is upright or tipped over.

40. A method according to claim 35, wherein the status if the bin comprises whether a lid of the bin is open or closed.

41. A system for indicating information about bins at a location, where each bin at the location is allocated to a different type of waste, the system comprising:
a device separate from the bin and also allocation to the location;
a bin sensor allocated to the location for each bin, each bin sensor configured to measure the level of waste in each bin and the status of each bin, wherein each bin sensor is configured to transmit the level of waste in the respective bin and the status of the respective bin along with an identifier of the respective bin sensor, where the identifier is associated with the respective bin and the allocated location;
a receiver of the transmission from the bin sensors;
a processor configured to determine when collection of waste from each bin is pending based on the location of each bin and scheduling information about when each bin is expected to have its waste collected;
a transmitter for transmitting to the device of one or more of:
the level of rubbish in each bin, the status of each bin and an indication of when collection of waste from each bin is pending; and
the device is configured to receive transmissions from the transmitter and to display based on the received transmissions:
the level of waste in each bin, the status of each bin and when collection of waste from one of the bins is pending an indication that collection of waste from the respective bin is pending.

42. A device that is separate from bins allocated to a location, the device being allocated to the location, the device comprising a receiver for receiving signals from a server in respect of the bins allocated to the location indicating one or more of:
the level of waste in each bin, a status of each bin, and an indication that collection of waste from one or more of the bins is pending;
a processor for processing the signals and activation of a display accordingly;
wherein the display is configured to display in respect of each bin:
the level of waste in each bin; the status of each bin and whether collection of waste from each bin is pending.
